(19) United States
(12) Patent Application Publication
(10) Pub. No.: US 2014/0191494 A1
(43) Pub. Date: Jul. 10, 2014

(54) BELLOWS OF A GANGWAY OF AN ARTICULATED VEHICLE AND ARTICULATED VEHICLE FOR PUBLIC PASSENGER TRANSPORT WITH SUCH A BELLOWS

(71) Applicant: HUBNER GMBH & CO. KG, Kassel (DE)

(72) Inventors: Volker Junke, Felsberg (DE); Reinhard Hubner, Kassel (DE)

(73) Assignee: HUBNER GMBH & CO. KG, Kassel (DE)

(21) Appl. No.: 14/151,326

(22) Filed: Jan. 9, 2014

(30) Foreign Application Priority Data
Jan. 9, 2013 (DE) DE202013000165.8

(51) Int. Cl. B60D 5/00

(52) U.S. Cl. CPC B60D 5/003
USPC 280/403

(57) ABSTRACT

A bellows for a gangway of an articulated vehicle, the articulated vehicle having at least two articulately connected vehicle parts, and has an elastic sheath on its outer side.

### CROSS REFERENCE TO RELATED APPLICATIONS

This patent application is the U.S. national phase and claims priority to DE 20 2013 000 165.8, filed Jan. 9, 2013, the contents of which are incorporated herein in their entirety.

### FIELD OF THE INVENTION

The invention relates to a bellows of a gangway for an articulated vehicle of the type having at least two articulately connected vehicle parts, such as a rail vehicle or an articulated bus.

A vehicle for public passenger transport with such a bellows is also an object of the invention.

### BACKGROUND OF THE INVENTION

In a road or rail vehicle, a gangway has at least one bellows and a platform and bridge enclosed by the bellows in the manner of a tunnel, which allows persons to move from one vehicle part of an articulated vehicle to the other. In articulated busses, more specifically, the bellows not only encloses the platform but also the pivot joint between the vehicle parts.

In high speed trains, more specifically, an inner and an outer bellows are provided as part of the gangway between the two articulately connected vehicle parts, the outer bellows enclosing the inner bellows in a spaced relationship. Such a construction is chosen in order to absorb the considerable pressure surges occurring e.g. when entering a tunnel with regard to the interior space. A disadvantage of the known design of two bellows mounted inside each other is that the outer bellows is placed at a considerable radial distance from the car body wall, which leads to the formation of vortices in the area of the bellows, more specifically at high speeds, which has a negative effect on the aerodynamics of the train. In this respect, EP 2 353 894 A1 not only discloses circumferentially disposing the outer bellows in the area of the respective car body wall of two articulately connected vehicles but also providing a corrugated bellows in a neutral position of the bellows, i.e. when the two vehicles are located in one plane, the wavelike, U-shaped bellows elements of which have a substantially perpendicular cross-section with a planar web, thus resulting in a substantially completely flat outer wall of the corrugated bellows during straight ahead travel. This means that substantially no or only minor vortices are formed as opposed to when the bellows elements forming the corrugated bellows are indeed wave-shaped, i.e. have a rounded contour in a cross-sectional view.

However, with such bellows, the bellows elements of which have a substantially rectangular cross-section, vortices are immediately formed when such vehicles or trains drive through a narrow bend, since gaps appear between the individual bellows elements on the outer side of the bend. The bellows is compressed on the inner side of the bend, so that the bellows elements bulge slightly outward in the area of the web.

### SUMMARY OF THE INVENTION

The problem to be solved by the invention is therefore to avoid the formation of vortices on the outer side of the bellows irrespective of the respective driving situation, i.e. irrespective of whether the train travels straight ahead or through a bend.

In order to solve the problem, it is proposed according to the invention that the bellows has an elastic sheath on its outer side, the elastic or flexible sheath preferably resting on the bellows. This means that the sheath encloses the bellows in the manner of a stocking. It is more specifically provided that the elastic or flexible sheath rests on the bellows under tension, i.e. in a stretched state. The extent of the elongation is hereby advantageously chosen so that the sheath on the bellows does not form any creases on the inner side of the bend.

In this context, if one imagines that the bellows consists of individual wave-shaped bellows elements, i.e. elements, the cross-section of which is substantially characterized by a round outward bulge, the sheath covers the wave-shaped outer contour of the bellows, with the consequence that the bellows appears outwardly as a completely flat structure. The formation of vortices is thus avoided. Such a sheath is usable not only with corrugated bellows but also with folded bellows.

The sheath is formed by an elastic or flexible material, the sheath being extensible in the direction of the longitudinal axis and/or transversely to the longitudinal axis of the sheath. From this it is clear that the sheath, that advantageously extends along the entire length of the bellows and also advantageously completely encloses the bellows along its circumference, is more specifically tensioned in the longitudinal direction of the vehicles in such a manner that when driving through a bend, no creases are formed in the sheath even on the side of the bellows located on the inner side of the bend. The elasticity is calculated in such a manner that the sheath is not damaged by overextension on the outer side. In addition, the sheath can also rest on the bellows under radial tension. In this context, it has turned out to be more specifically advantageous if a fabric is used as a material for the sheath that is formed by a woven fabric, a warp-knitted fabric or a weft-knitted fabric. The elasticity of a warp-knitted or weft-knitted fabric is the direct consequence of the fact that it is knitted. However, as in the case of a woven fabric, the threads or yarns can also be made of an elastic material, i.e. they can have a certain degree of elasticity. In this context it is more specifically provided that threads of reticulated silicone rubber can be used for the fabric, which have elastic modulus values ranging from 20 to 100 cN/800%, more specifically ranging from 20 to 80 cN/100%. In a woven fabric, the warp and weft threads can both be made from such an elastic material. However, if it should be sufficient to provide elasticity in only one direction, it is also possible to design either the warp or the weft threads as elastic threads in the above sense.

According to another feature, the sheath is adapted to be fastened to the bellows. At high speed the sheath tends to lift off the bellows due to suction, which means that the sheath bulges outward. In order to prevent such a bulging, it is provided according to another feature of the invention, that the sheath is adapted to be fastened to the bellows. This means that the sheath is not only fastened to the bellows or the respective car body at its ends, i.e. in the area of the front side of the car bodies, but that there can also be a connection with the bellows along the entire length of the sheath. In this respect, it can be provided to connect the sheath to the bellows in the area of each corrugation or pleat, or to provide a connection to the sheath for example only on one in two or one in three corrugations or folds.

According to another feature, the sheath is adapted to be fastened on the bellows. At high speed the sheath tends to lift off the bellows due to suction, which means that the sheath bulges outward. In order to prevent such a bulging, it is provided according to another feature of the invention, that the sheath is adapted to be fastened on the bellows. This means that the sheath is not only fastened to the bellows or the respective car body at its ends, i.e. in the area of the front side of the car bodies, but that there can also be a connection with the bellows along the entire length of the sheath. In this respect, it can be provided to connect the sheath to the bellows in the area of each corrugation or pleat, or to provide a connection to the sheath for example only on one in two or one in three corrugations or folds.

A vehicle for public passenger transport, characterized by a bellows according to the invention is also an object of the invention.

### BRIEF DESCRIPTION OF THE FIGURES

In the following, the invention is explained in more detail based on the drawings.

FIG. 1 is a schematic showing a two-part vehicle, the two vehicle parts being connected by a gangway with a bellows.

FIG. 2 is a cross-sectional view taken along line II-II in FIG. 1;

FIG. 3 is a cross-sectional view taken along line in FIG. 2;

FIG. 4 is a schematic showing the gangway in a perspective view.

### DETAILED DESCRIPTION OF THE INVENTION

An articulated vehicle 3 formed by two articulately connected vehicle parts 1 and 2 includes a gangway 10. A pivot joint or coupling 5 is located under the gangway 10 connecting the two vehicle parts 1 and 2.

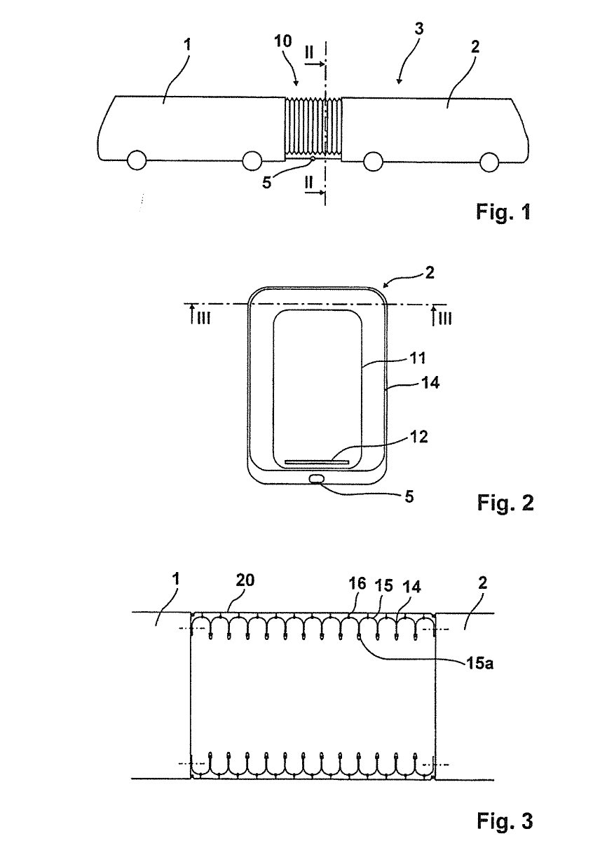

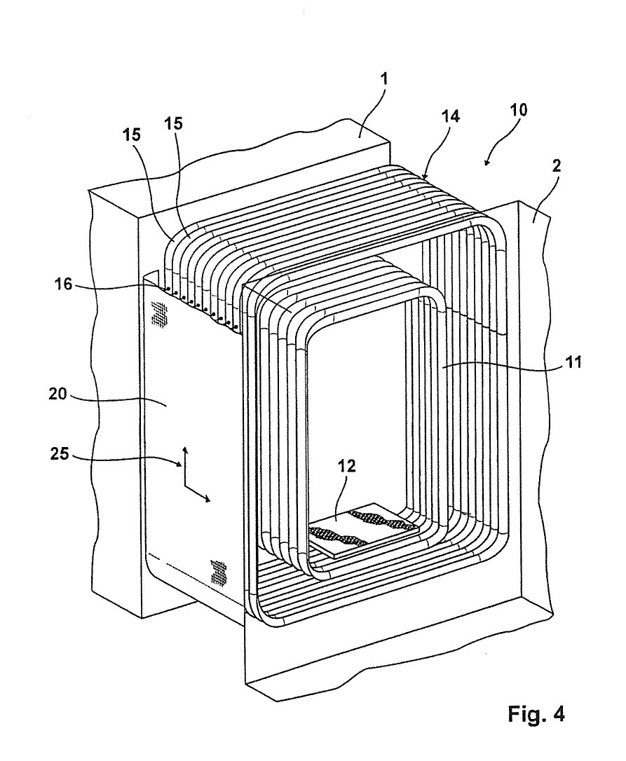

The object of the invention is the configuration of the outer bellows 14 of the gangway 10. In this context, reference is first made to FIG. 2 which shows a section according to line II-II in FIG. 1 and in which the inner bellows 11 and the outer bellows 14 are recognizable. The outer bellows 14 extends in the area of the lateral walls and of the roof in such a manner that it follows the course of the contour of the car body of vehicle part 2.

FIG. 2 also shows the gangway bridge or platform 12 inside the inner bellows 11 which allows persons to move between the vehicle parts 1 and 2.

The object of the invention is the configuration of the outer bellows 14 according to FIG. 3, the inner bellows 11 being left out for more clarity. The outer corrugated bellows 14 is composed of individual wave-shaped bellows elements 15 that are connected to each other by bellows frames 15a. The outer bellows 14, which is fastened at its ends to the car bodies of the two vehicle parts 1 and 2, is enclosed by a sheath 20 that is formed by an extensible fabric. The sheath is extensible in the direction of the longitudinal axis of the bellows or of the sheath as well as in the transverse direction relative to the longitudinal axis of the bellows or of the sheath according to the arrows 25. This means that the sheath 20 is pulled under tension over the outer bellows like a stocking and is connected to the bellows in the area of the crests of the individual wave elements by webs 16. The webs 16 for connecting the sheath 20 to the bellows are provided on the circumference of the bellows at determined intervals. The length of the webs is variable. The length of the webs advantageously tends towards zero, i.e. the web connects the hull directly to the bellows. The web 16 can hereby be formed by sewing or gluing.

### LIST OF REFERENCE NUMBERS

1 vehicle part

2 vehicle part

3 articulated vehicle

5 pivot joint or coupling

10 gangway

11 inner bellows

14 outer bellows

15 wave-shaped bellows element

15a bellows frame

16 web

20 elastic sheath

1-17. (canceled)

18. A bellows for a gangway of an articulated vehicle of the type having at least two articulately connected vehicle parts, the bellows comprising:
an outer bellows having an outer side; and
an elastic sheath disposed on the outer side of the outer bellows.

19. A bellows in accordance with claim 18, wherein the elastic sheath rests on the outer side of the outer bellows.

20. A bellows in accordance with claim 18, wherein the elastic sheath rests on the outer side of the outer bellows under tension.

21. A bellows in accordance with claim 18, wherein the outer sheath is fastened to the outer bellows.

22. A bellows in accordance with claim 21, further comprising webs, the outer sheath being fastend to the outer bellows by the webs.

23. A bellows in accordance with claim 18, wherein the elastic sheath extends along a length of the outer bellows.

24. A bellows in accordance with claim 18, wherein the elastic sheath circumferentially encloses the outer bellows.

25. A bellows in accordance with claim 18, wherein the elastic sheath has a longitudinal axis and the elastic sheath is extensible in an axial direction and/or a transverse direction to the longitudinal axis of the sheath.

26. A bellows in accordance with claim 18, wherein the elastic sheath has a longitudinal axis and the elastic sheath is extensible in a transverse direction to the longitudinal axis of the sheath.

27. A bellows in accordance with claim 18, wherein the elastic sheath has a longitudinal axis and the elastic sheath is extensible in an axial direction to the longitudinal axis of the sheath.

28. A bellows in accordance with claim 18, wherein the elastic sheath comprises a fabric.

29. A bellows in accordance with claim 28, wherein the fabric comprises a woven fabric, a warp-knitted fabric or a weft-knitted fabric.

30. A bellows in accordance with claim 28, wherein the fabric comprises extensible threads or yarns.

31. A bellows in accordance with claim 28, wherein the fabric is coated with an elastomer.

32. A bellows in accordance with claim 18, wherein the sheath has ends configured to connect to the vehicle parts.

33. A bellows in accordance with claim 30, wherein the threads or yarns comprise a reticulated silicone rubber.

34. An articulated vehicle, comprising:
at least two articulately connected vehicle parts;
a gangway extending between the vehicle parts; and
a bellows in accordance with claim 18.
